(19) United States
(12) Patent Application Publication
(10) Pub. No.: US 2002/0106503 A1
(43) Pub. Date: Aug. 8, 2002

(54) Polypropylene core composite structural member

(75) Inventors: Russell Allen Monk, Salem, OR (US); Robert A. Schofield, Melbourne, FL (US); Shau-Tarng Lee, Oakland, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (U.S.)

(21) Appl. No.: 09/776,576

(22) Filed: Feb. 2, 2001

(51) Int. Cl. B32B 3/26

(52) U.S. Cl. 428/314.4; 428/317.1; 428/319.1; 428/319.3

(57) ABSTRACT

Core for a composite structural member comprises rigid, extruded, closed-cell polypropylene foam in which the surfaces are skived to provide adhesive bonding to structural skin layers. Panel made from core in accordance with the invention has shear strength of from about 60 to 200 psi at a density of 3 to 8 pcf and is suitable for use in marine craft, vehicles, and in building construction. The core is kerfed or “kiss cut” prior to application of adhesive for use in forming curved surfaces without a scrim layer.

### FIELD OF THE INVENTION

This invention relates to composite structural panels used in the construction of marine craft and land transportation vehicles and in building construction and the like.

### BACKGROUND OF THE INVENTION

High strength, lightweight composite structural panels are used to build boats, free-standing buildings, and trucks and other land transportation vehicles for transporting goods of various kinds. Composite structural panels typically are constructed in a sandwich configuration of a high-performance structural skin laminate material bonded on each side thereof to a structural core. The panel is analogous to an I-beam. The structural skins provide tensile and compressive strength to the panel. The core in the laminate holds the two structural skin laminates apart and maintains the panel geometry. The core typically makes the composite laminate lighter and thicker while maintaining the stiffness and shear strength of the panel overall. It is also desirable, where possible, to select a core that will reduce the cost of the laminate. However, high strength, lightweight cores typically are somewhat expensive.

Typical core materials include rigid polyvinylchloride foams, balsa wood, plywood, and “honeycomb” cores. Core materials for marine, chemical tank, transportation, and outdoor exposure are selected to be resistant to water and chemicals in addition to having the required shear strength, impact resistance, cost, and weight restrictions that may be imposed. Polyvinylchloride foam cores (“PVC” foam cores), while economical and lightweight, tend to decrease the heat resistance of the panel for the strength that is often required. PVC foams have a relatively low heat distortion temperature in use of about 160° F. Florida sun can ordinarily produce about 180° F. in a black coated laminate. Other colors can produce 140 degrees, which means that PVC foams are subject to premature deterioration since the temperatures encountered in use can approach or, in some cases exceed, the heat distortion temperature for PVC.

Balsa wood is lightweight and panels prepared from balsa core can last for a long time if care is taken to seal the wood. However, balsa that is not properly sealed is prone to rot when subjected to high moisture levels. Plywood is somewhat heavier but suffers from similar problems as balsa in the presence of excess moisture. Honeycomb cores made with paper, urethane foam, aluminum, and polypropylene have been prepared and are generally among the least expensive core materials. However, honeycomb cores can be prone to take up water and some have low impact resistance.

Curved surfaces are typically prepared from rigid core materials by cutting all the way through the core material in multiple locations and applying a flexible light fabric scrim layer to hold the core pieces together so that the core can be bent to conform to the radius desired. However, the spaces between adjacent cut portions of core can be problematic. The spaces may allow water or chemicals to migrate into the structure.

An extremely wide variety of core materials is available for the construction of composite structural panels, and it is often difficult to select a core material that is appropriate for a particular use. It would be desirable to develop a core material that meets or exceeds most of the requirements for a wide variety of applications to simplify the selection of core materials and to provide a high performance, cost effective alternative to the composite structural engineer.

### SUMMARY OF THE INVENTION

This invention provides a composite structural member in which the core material is a rigid, extruded, closed-cell polypropylene polymer foam layer. Light weight panels can be prepared that readily conform to curved surfaces, resist osmotic permeation by water and other fluids and chemicals, and are resistant to deterioration at temperatures expected in use. The panels are bouyant and useful in boat construction.

Light weight core of low density of from about 2 to 8 pcf and shear strength of from about 60 to 200 psi can be made from high melt strength polypropylene copolymer physically expanded with gaseous blowing agents. Lower and higher density core can be produced and other polypropylenes can also be used in the practice of the invention, although not necessarily with equivalent results. Use of polypropylene as a core material previously normally has been limited to honeycomb structures, at least in part because of insufficient shear strength associated with poor bonding of the structural skins to the closed cell core surface of extruded polypropylene foam. The surface of the polypropylene foam core is skived in the practice of the invention to open the cells at the surface for high shear strength bonding of the external skin layers to alleviate this problem.

The rigid polypropylene core of the invention can be made to conform to curved surfaces, including compound curves, by knife kerfing, which is sometimes referred to as “kiss-cutting,” on one or both surfaces. A small hinge of uncut foam remains intact on the surface opposite the cut so that the core can bend away from the cut on the hinged side. Hinged cuts can be placed on opposing lateral surfaces of the core, offset from the cuts on the opposite surface, so that compound curves can be created. The scrim layer typically used in prior constructions can be eliminated and problems typically associated with prior panels that are cut all the way through are substantially reduced or eliminated.

The term kerfing as used in connection with this invention means cutting partially through the foam core to enhance bending. Kerfing can be accomplished with a knife, saw or other cutting instrument.

The structural skin layers can be selected from any of a variety of materials, depending on the performance parameters desired, and successfully bonded to the skived surface of the polypropylene core. Structural skin materials include, but are not limited to, aluminum; steel; titanium and other metals; thin plywood sheets; high-pressure laminates (“HPLs”), including, but not limited to, Formica, which is a trademark for high-pressure laminated sheets of melamine and phenolic plastics; and reinforced plastics, including fiber-reinforced plastics (“FRPs”) of various kinds. The structural skins typically will have a thickness of less than about ¼ inch. The core typically will have a thickness of from about ¼ inch to 2½ inches.

Structural skins can be bonded to the core in several ways. A variety of thermoplastics and thermosetting resins can be used to bond the structural skins to the core, adhesively penetrating the open cells on the surface of the skived foam to provide a mechanical bond of high shear strength. Heat can be applied to either the skin or the core or both sufficient to bond the skin to the core in the absence of a separate adhesive layer. The core can also be placed in a mold and adhered directly to uncured fiber reinforced plastic without a separate adhesive, which is useful for making curved surfaces.

Thus, the invention provides a lightweight, strong, water-resistant composite structural member in which the core is made from a skived, closed-cell, extruded polypropylene foam core.

### BRIEF DESCRIPTION OF THE DRAWINGS

Having thus described the invention in general terms, reference will now be made to the accompanying drawings, which are not necessarily drawn to scale, and wherein:

FIG. 1 is a perspective cross sectional view of a composite structural member of the invention comprising a skived polypropylene foam core sandwiched between structural skin layers;

FIG. 2A is a cross sectional view of a closed cell polypropylene foam layer prior to skiving to open the cells on the surface;

FIG. 2B is a cross sectional view of a closed cell polypropylene foam layer having both surfaces skived and suitable for use in the practice of the invention as a core in a composite structural panel;

FIG. 3 is a perspective cross sectional view of a composite structural member of the invention in which the core has been kiss-cut on one lateral surface to conform to a radius of curvature; and

FIG. 4 is a perspective cross sectional view of a composite structural member of the invention in which the core is kiss-cut on both sides to provide a structure having a compound curve.

The invention is described more fully in the detailed description below, referring to the accompanying drawings. However, the invention can be embodied in many different forms and should not be construed as limited to the embodiments set forth; rather, these embodiments are provided so that this disclosure will be thorough and complete, and will fully convey the scope of the invention to those skilled in the art. Like numbers refer to like elements throughout.

### DETAILED DESCRIPTION OF THE INVENTION

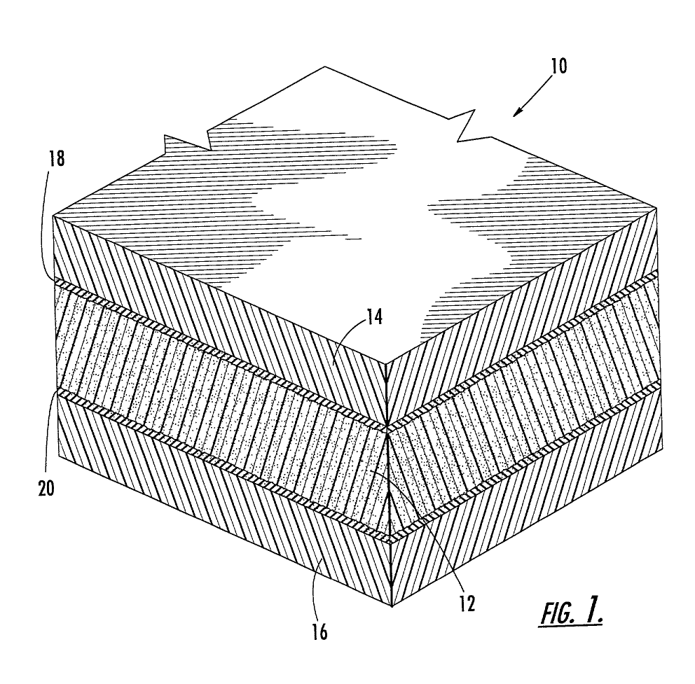

FIG. 1 shows generally at 10 a composite structural member of the invention that comprises a rigid, extruded, skived, closed-cell polypropylene foam core 12 sandwiched between structural skin layers 14 and 16. Adhesive layers 18 and 20 bond the structural skin layers to the polypropylene core.

The polypropylene foam layer 12 is a rigid, extruded, closed-cell polypropylene foam made in a conventional manner. The foam is typically extruded into a sheet or plank configuration of from about ¼ to 2½ inches in thickness. Thinner and thicker foams can be prepared and used in the invention as desired. However, the core normally will be thicker than the structural skin layers. The extruded polypropylene foam for use in the practice of the invention typically will not be of much less than ¼ inch in thickness to provide useful shear strength in composite panels. The core normally will not exceed more than about 2½ inches in thickness, although thicker foam cores of up to about 15 inches prepared in accordance with the invention may be useful in certain applications.

The term polypropylene should be understood in a broad sense to include thermoplastic crystalline homopolymer, typically with a molecular weight of 40,000 or more, lower molecular weight amorphous homopolymer, polypropylene copolymers prepared with other monomers, including, for example, ethylene, in which polypropylene is the dominant component and is present in an amount of at least about 80% of the molecular weight of the copolymer, and blends of polypropylene with other polyolefins wherein the polypropylene is present in an amount of at least about 80% by weight of the blend.

Many of these polypropylene foams are of relatively low melt strength and can be prepared as expanded cellular foam products by using chemical blowing agents that are incorporated into the resin and produce gas for expansion by chemical reaction. Normally, polypropylene foams produced with chemical blowing agents can achieve densities of about 15 pcf or greater, up to less than about 60 pcf. Many polypropylene resins have a density in their unexpanded state of about 60 pcf. Foams prepare with chemical blowing agents should be useful in the practice of the invention where a higher weight product is appropriate.

Lighter polypropylene foams, typically of density about 2 to 8 pcf and having a shear strength of about 60 to 200 psi, can be produced with physical blowing agents from high melt strength polypropylene resins. For example, a high melt strength polypropylene copolymer is available from Montell in Montreal, Canada and is designated PF 814. It should also be possible to produce foams of lower density from these resins, down to about ½ to 1 pcf, if desired. Foams of higher density, up to 13 to 15 pcf or higher, can be produced, if core of that density is needed for a particular application. Thus, polypropylene core can be prepared in a variety of densities depending on the results desired, of from about 0.5 to less than 60 pcf.

The structural skin layers 14 and 16 may be the same or different. The skins typically are prepared in a thickness of about ¼ of an inch or less from a wide variety of available materials depending on the requisite properties for a particular structural application of tensile and compressive strength, shear strength, stiffness, chemical resistance, moisture resistance, weight, cost, and other properties. Examples of such skins include, but are not limited to, aluminum, steel, titanium and other metals, thin plywood, high pressure laminates (“HPLs”), and reinforced plastics generally, including fiber reinforced plastics (“FRPs”).

FRPs suitable for use in the practice of the invention include a wide variety of materials prepared from thermoplastics or thermosetting resins into which reinforcement fibers have been dispersed to reinforce the matrix. Thermosetting resins include, but are not limited to, epoxies, polyesters, vinylesters, methamethacrylate (MMA), and phenolics. Thermoplastics include, but are not limited to, polycarbonates, acrylonitrile-butadiene-styrene resins (“ABS” resins), polypropylene, polystyrene, acrylics, polyvinyl chloride, polyvinyl acetate, and ethylene-vinyl acetate copolymer.

Reinforcement of the matrix can be provided by a variety of materials dispersed in a plastic matrix including, but not limited to, fibers, filaments, and whiskers of glass, metal, boron, aluminum silicate, carbon, aramid, polyethylene, quartz, basalt, E-glass, and S-glass.

An adhesive, shown in FIG. 1 as layers 18 and 20, bonds the polypropylene core to the structural skin layers. In some embodiments, the structural skin in direct contact with the surface of the core provides the necessary adhesion. In other embodiments, a separate adhesive may be applied. A variety of adhesives, including, but not limited to, thermoplastic adhesives and thermosetting resins, are useful in the practice of the invention. The adhesive should be applied to the core or the skin to provide 100 percent lamination over the entire surface of the core and skin and should be selected to have at least the shear strength of the core, which typically is the limiting shear strength of the composite structural member.

Adhesives useful in the practice of the invention are selected at least in part depending on the structural skin that has been selected for a particular application. Adhesives include, but are not limited to, thermoplastic adhesives and thermosetting resins. Thermosetting resins include, but are not limited to, epoxies, polyesters, vinylesters, methamethacrylate (MMA), and phenolics. Thermoplastics include, but are not limited to, polycarbonates, acrylonitrile-butadiene-styrene resins (“ABS” resins), polypropylene, polystyrene, acrylics, polyvinyl chloride, polyvinyl acetate, and ethylene-vinyl acetate copolymer.

As an alternative to a separately applied adhesive, in some instances the structural skin can be bonded to the core by applying heat to the skin, the core, or both to cause the skin to bond directly to the core. Many of the same thermoplastics and thermosetting resins useful as adhesives are also useful as the matrix for reinforced plastics, including a wide variety of FRPs. FRPs can be bonded directly to the core by contacting the core with fresh, uncured catalyzed thermoplastic or thermosetting resin and allowing the matrix to adhesively cure on the core. Curved surfaces can be made in this manner by laminating a first skin layer of FRP into a mold, inserting a core, and then laminating a second FRP layer into the mold and allowing the composite to cure.

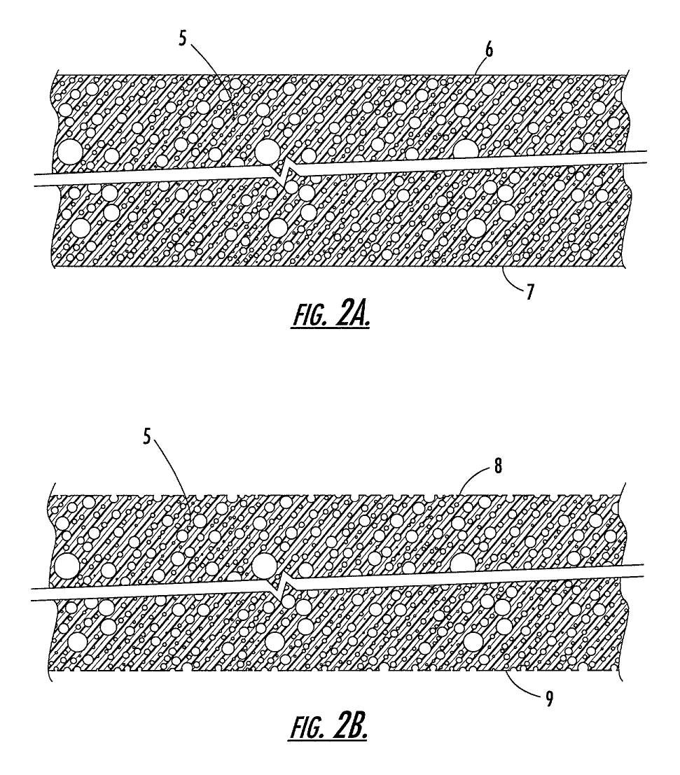

It is important to provide an adequate bond of the structural skin layer to the core over the entire surface of the skin and the core. The polypropylene core is skived to open the layer of cells at the surface of the foam. In skiving, the surfaces of the foam are shaved or cut off to provide a layer of open cells at the surface. Opening the cells of the foam allows the adhesive to penetrate into these cells and to provide a mechanical bond of the requisite shear strength. FIGS. 2A and 2B show sequential cross sectional views of an extruded, closed-cell polypropylene foam core prepared for use in the practice of the invention as a composite structural member. The foam core is shown generally at 5 in FIG. 2A prior to skiving. The cells on the opposing lateral surfaces 6 and 7 are closed and adhesive is generally not able to form an adequate bond with the closed cell surface. Foam core 5 is shown in FIG. 2B after the surfaces have been skived to open the cells on the surfaces. Skived surfaces are illustrated as surfaces 8 and 9. Skiving is a conventional practice that is believed to be well within the purview of the person having ordinary skill in the art.

The composite structural member of the invention possesses the rigidity, shock absorption, and temperature resistance that is necessary for boat structures, transportation vehicles, and buildings and compares favorably to polyurethane foams and partially cross-linked vinyl foams that have previously been used in similar structures. Shear strength for polypropylene foam core produced in accordance with the invention ranges from about 60 to 200 psi for polypropylene foam core of from about 3 to 8 pcf density, without sacrificing heat resistance. The heat distortion temperature for polypropylene resin is about 250° F. The product is suitable for many applications at a shear strength of 60 to 110 psi. The heat distortion temperature for polypropylene foam can typically be expected to be less than for the unexpanded resin, but should still be in the range of from about 225 to 250° F., which is well above expected temperatures in most use.

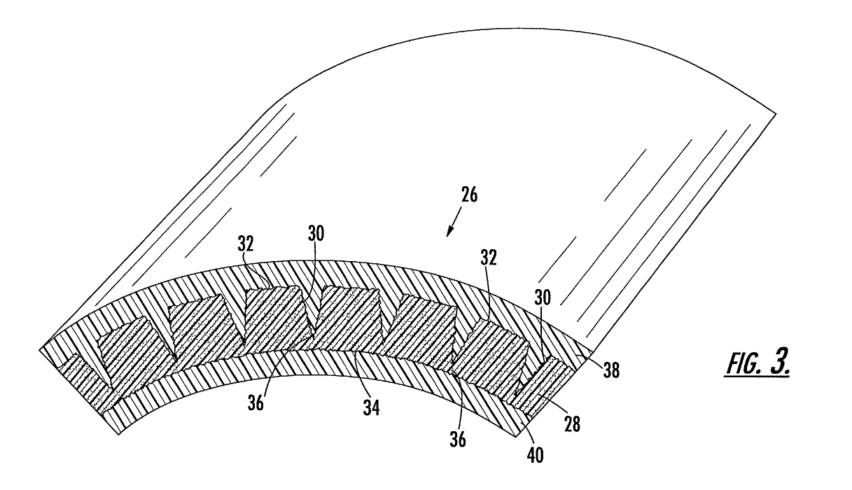

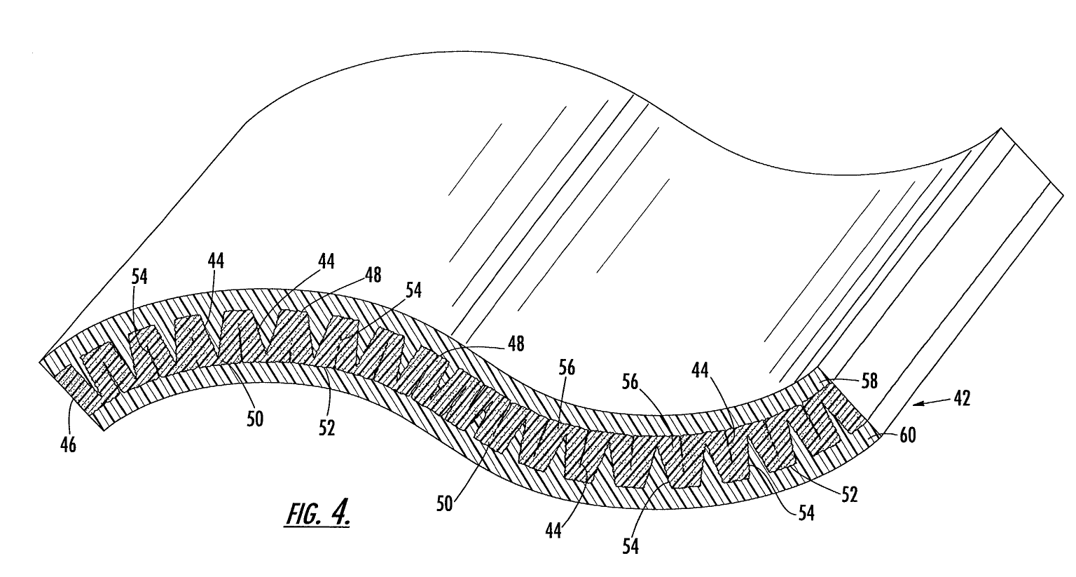

The composite structural member of the invention is particularly useful for boat construction and can be used in both the hull and deck areas of a boat. Panels can be prepared with some flexibility for minor radiuses, and the core can be cut to conform to more highly curved surfaces, as when used in a boat hull or in certain portions of a boat deck. FIGS. 3 and 4 illustrate embodiments in which the core is cut to conform to a curved surface. The polypropylene foam is typically cut after skiving and prior to adhesion of the structural skin layers. The foam can be cut entirely through its thickness in a conventional manner as is used with conventional cores and a scrim applied, but substantial benefits of the invention are available through avoiding this practice. The foam instead is kerfed by cutting through most of its thickness leaving about 1/32 to 1/16 inch of the surface of the foam intact on one side to form a hinge about which the two halves of the foam body can be rotated away from the cut in the direction of the hinge. Multiple can be made in a foam body for single panel. Typically, these cuts will be made about 1¼ inches apart and at right angles so that a pattern similar to floor tile is created. The distance between the cuts depends in part on the radius of curvature that is sought.

Offset hinged cuts can be made on opposite lateral surfaces of the foam core so that the foam can be bent in at least two planes and compound curves can be made in a single core. The cuts will usually be offset from cuts on the opposite surface by a distance of at least about ½ inch, although this distance is variable depending on the curvature sought.

After the cuts are made, the core is bent to the desired shape and the adhesive layer, if any, and structural skins are applied. When bent, the cuts open up into a V shape with the hinge at the bottom of the V. In one embodiment, as in when a molded panel is created for boat construction, a first layer of FRP is placed in a mold and then the skived and cut polypropylene foam core is placed in the mold in contact with the uncured plastic matrix, bending to the shape of the matrix layer. A second layer of FRP is then placed in the mold and fills the open cells on the opposite side of the foam core.

The surfaces of the foam placed into contact with the matrix may be wetted with the matrix prior to insertion in the mold to remove air pockets and to fill the cuts and open cells of the skived foam surfaces. The wetted foam core is then pushed into contact with the thermoplastic or thermosetting resin in the mold to blend the wetted surfaces of the foam and matrix and to form a high shear strength mechanical bond.

A molded structural composite member is illustrated in FIG. 3 generally at 26 that has been cut to conform to a curved surface in the manner described above. A polypropylene core 28 has cuts 30 formed along one skived surface of the core 32 at intervals of about 1¼ inches that extend through the core to within about 1/16^{th} inch of the opposite surface 34 of the core. The uncut portion of the core remaining at the opposite surface forms a hinge 36 about which the core can bend to conform to a radius of curvature. The hinge should be sufficiently thick to maintain its integrity and sufficiently thin to provide bending and not snapping of the core, which is usually about 1/16^{th} inch. In the embodiment shown in FIG. 3, FRP resin layers 38 and 40 have been applied to the core in the manner described, filling up the open cells in each of the lateral skived surfaces 32 and 34 and the V-shaped cuts in the core that open up from surface 32 when the core is bent.

Illustrated generally at 42 in FIG. 4 is another embodiment of a structural composite member of the invention in which cuts 44 are applied to a polypropylene foam core 46 along surface 48 to form hinges 50 along the opposite surface 52. Cuts 54 are applied along surface 52 of the core to form hinges 56. Cuts 44 and 54 are offset about ½ inch on opposite sides of the core. The cuts open if the core is bent along the hinge in a direction away from the cut, but otherwise remain closed. FRP resin layers 58 and 60 have been applied to the core in the manner described above, filling up the open cells in each of the lateral skived surfaces 48 and 52 and the V-shaped cuts in the core that open up from surface when the core is bent.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A composite structural member comprising, in a sandwich configuration, a core adhesively bonded on opposite lateral surfaces thereof to structural skin layers that may be the same or different, said core comprising an extruded, closed-cell polymer foam layer made from a polymer selected from the group consisting of polypropylene homopolymer, copolymers of polypropylene and other monomers wherein the polypropylene is at least about 80% by weight of the copolymer, and blends of polypropylene and one or more different polyolefins wherein the polypropylene is present in an amount of at least about 80% by weight of the blend, and wherein each said opposite lateral surface of said core is skived to provide a layer of open cells for adhesive bonding to said skin layers.

2. The composite structural member of claim 1 wherein said structural skin layers are selected from the group consisting of aluminum, steel, titanium, plywood, high-pressure laminates, and reinforced plastics.

3. The composite structural member of claim 1 wherein said core is cut through most of its thickness from a lateral surface to form a hinge at the opposite lateral surface about which said core can be bent.

4. The composite structural member of claim 1 wherein said structural skin layers comprise fiber-reinforced plastic.

5. The composite structural member of claim 1 wherein said core and said structural skins are adhesively bonded by a thermoplastic adhesive or thermosetting adhesive applied between said core and said structural skin layer.

6. The composite structural member of claim 1 wherein said core is from about ¼ to 2½ inches thick.

7. The composite structural member of claim 1 wherein each said skin layer is less than about ¼ of an inch thick.

8. The composite structural member of claim 1 wherein said polypropylene foam has a density of from about 3 to 8 pcf and a shear strength of from 60 to 200 psi.

9. The composite structural member of claim 1 wherein said polypropylene foam has a density of from about 4 to 5 pcf.

10. A marine craft comprising composite structural members as recited in claim 1.

11. A composite structural member comprising a foam core of skived, extruded, physically expanded, closed-cell high melt strength polypropylene copolymer sandwiched between structural skin layers selected from the group consisting of aluminum, steel, titanium, plywood, high-pressure laminates, and fiber-reinforced plastics, and wherein said core is adhesively bonded to said skin layers.

12. The composite structural member of claim 11 wherein said skin layers and said core are adhesively bonded by a thermoplastic or thermosetting resin.

13. The composite structural member of claim 11 wherein said fiber-reinforced plastic has a matrix of a thermoplastic or thermosetting resin.

14. A method of preparing a rigid composite structural member comprising the steps of extruding a closed-cell polymer foam layer made from a polymer selected from the group consisting of polypropylene homopolymer, copolymers of polypropylene and other monomers, and blends of polypropylene and one or more different polyolefins, skiving each of the lateral surfaces thereof to open the cells at the surface, and adhesively bonding a structural skin to each lateral surface.

15. The method of claim 13 further comprising, prior to the step of adhesive bonding of the skins, the step of cutting the core through most of its thickness from a lateral surface to form a hinge at the opposite lateral surface about which said core can be bent.
